(19) United States
(12) Patent Application Publication
(10) Pub. No.: US 2026/0222356 A1
(43) Pub. Date: Jul. 30, 2026

(54) Network communication apparatus and method having a dynamic packet transmission sorting mechanism

(71) Applicant: REALTEK SEMICONDUCTOR CORPORATION, Hsinchu (TW)

(72) Inventor: TING-YU LEE, Hsinchu (TW)

(21) Appl. No.: 19/348,978

(22) Filed: Oct. 3, 2025

(30) Foreign Application Priority Data
Oct. 25, 2024 (TW) 113140933

(51) Int. Cl. H04L 47/56

(52) U.S. Cl. CPC H04L 47/56

(57) ABSTRACT

A network communication apparatus having a dynamic packet transmission sorting mechanism is provided. A packet categorization circuit sets each of low-latency packets as a selected low-latency packet to be stored in a corresponding selected low-latency queue circuit. A transmission sorting circuit calculates a queue time parameter of the selected low-latency packet to be sorted with the other low-latency packets to update a sorting list. The queue time parameter is a ratio of an exceeding time and a dynamic service time threshold value configured by the corresponding selected low-latency queue circuit. A communication circuit transmits the low-latency packets according to the sorting list. A dynamic adjusting circuit calculates a difference of a total packet transmission time of the selected low-latency packet from a target delay threshold value to dynamically adjust the dynamic service time threshold value according to the difference.

### BACKGROUND OF THE INVENTION

### 1. Field of the Invention

The present invention relates to a network communication apparatus and a network communication method having a dynamic packet transmission sorting mechanism.

### 2. Description of Related Art

A network communication apparatus such as an access point (AP) apparatus can transmit packets to a station (STA) apparatus through a wireless network under the request of the station apparatus. However, the station apparatus may submit different service requirements when different application programs are operated therein, where different delay threshold values of the packet transmission are requested by the different service requirements.

For example, when the station apparatus operates a video call application or a real-time gaming application that has a low-latency requirement, a low-latency requirement is submitted in the hope of receiving the packets as soon as possible. When the station apparatus operates a video streaming application or a device remote controlling application that has a non-low-latency requirement, a non-low-latency requirement is submitted such that the packets can be received within a longer range of time. If the network communication apparatus does not have different packet-processing policies according to the different service requirements, the low-latency requirement may not be satisfied such that the station apparatus can not receive the packets corresponding to the low-latency requirement in time.

### SUMMARY OF THE INVENTION

In consideration of the problem of the prior art, an object of the present invention is to supply a network communication apparatus and a network communication method having a dynamic packet transmission sorting mechanism.

The present invention discloses a network communication apparatus having a dynamic packet transmission sorting mechanism that includes a plurality of low-latency queue circuits, a packet categorization circuit, a transmission sorting circuit, a communication circuit and a dynamic adjusting circuit. The packet categorization circuit is configured to retrieve a plurality of low-latency packets having a low-latency requirement from a plurality of to-be-transmitted packets and set each of the low-latency packets to be a selected low-latency packet to determine a low-latency packet target apparatus that corresponds to the selected low-latency packet from a plurality of target apparatuses and further store the selected low-latency packet in a selected low-latency queue circuit disposed correspondingly to the low-latency packet target apparatus in the low-latency queue circuit. The transmission sorting circuit is configured to calculate a queue time parameter of the selected low-latency packet to be transmitted in each of a plurality of transmission timings so as to be sorted with the other low-latency packets according to the queue time parameter to update a sorting list, wherein the queue time parameter is a ratio between an exceeding time and a dynamic service time threshold value configured for the corresponding selected low-latency queue circuit, the exceeding time being an amount of time that a total queue time that the selected low-latency packet is stored in the selected low-latency queue circuit exceeds the dynamic service time threshold value. The communication circuit is configured to transmit the low-latency packets in an order according to the sorting list, so as to transmit the selected low-latency packet to the low-latency packet target apparatus. The dynamic adjusting circuit is configured to accumulate a total packet transmission time of the selected low-latency packet from a first time point that the selected low-latency packet begins to be stored in the selected low-latency queue circuit to a second time point that the selected low-latency packet is received by the low-latency packet target apparatus, and to calculate a difference between the total packet transmission time and a target delay threshold value that the low-latency packet target apparatus requests to dynamically adjust the dynamic service time threshold value according to the difference.

The present invention also discloses a network communication method having a dynamic packet transmission sorting mechanism that includes steps outlined below. A plurality of low-latency packets having a low-latency requirement are retrieved from a plurality of to-be-transmitted packets and each of the low-latency packets is set to be a selected low-latency packet by a packet categorization circuit. A low-latency packet target apparatus that corresponds to the selected low-latency packet is determined from a plurality of target apparatuses and the selected low-latency packet is further stored in a selected low-latency queue circuit disposed correspondingly to the low-latency packet target apparatus in a plurality of low-latency queue circuits by the packet categorization circuit. A queue time parameter of the selected low-latency packet to be transmitted in each of a plurality of transmission timings is calculated by a transmission sorting circuit, wherein the queue time parameter is a ratio between an exceeding time and a dynamic service time threshold value configured for the corresponding selected low-latency queue circuit, the exceeding time being an amount of time that a total queue time that the selected low-latency packet is stored in the selected low-latency queue circuit exceeds the dynamic service time threshold value. The selected low-latency packet is sorted with the other low-latency packets according to the queue time parameter to update a sorting list by the transmission sorting circuit. The low-latency packets are transmitted in an order according to the sorting list by a communication circuit, so as to transmit the selected low-latency packet to the low-latency packet target apparatus. A total packet transmission time of the selected low-latency packet from a first time point that the selected low-latency packet begins to be stored in the selected low-latency queue circuit to a second time point that the selected low-latency packet is received by the low-latency packet target apparatus is accumulated by a dynamic adjusting circuit. A difference between the total packet transmission time and a target delay threshold value that the low-latency packet target apparatus requests is calculated to dynamically adjust the dynamic service time threshold value according to the difference by the dynamic adjusting circuit.

These and other objectives of the present invention will no doubt become obvious to those of ordinary skill in the art behind reading the following detailed description of the preferred embodiments that are illustrated in the various figures and drawings.

### BRIEF DESCRIPTION OF THE DRAWINGS

FIG. 1 illustrates a block diagram of a network communication system according to an embodiment of the present invention.

FIG. 2 illustrates a block diagram of the network communication apparatus having the dynamic packet transmission sorting mechanism according to an embodiment of the present invention.

FIG. 3 illustrates a diagram of the transmission timings of the low-latency packets according to an embodiment of the present invention.

FIG. 4A and FIG. 4B illustrate diagrams of the transmission timings of the low-latency packets according to an embodiment of the present invention.

FIG. 5A and FIG. 5B illustrate diagrams of the transmission timings of the low-latency packets according to an embodiment of the present invention.

FIG. 6A illustrates a diagram of the transmission order of the low-latency packets and the non-low-latency packets in some approaches.

FIG. 6B illustrates a diagram of the transmission order of the low-latency packets and the non-low-latency packets according to an embodiment of the present invention.

FIG. 7 illustrates a flow chart of a network communication method according to an embodiment of the present invention.

### DETAILED DESCRIPTION OF THE PREFERRED EMBODIMENTS

An aspect of the present invention is to provide a network communication apparatus and a network communication method having a dynamic packet transmission sorting mechanism to categorize to-be-transmitted packets first and further sort the low-latency packets according to the queue time parameters thereof. The transmission of the low-latency packets can be performed and the dynamic service time threshold value related to the packets can be dynamically adjusted accordingly such that the low-latency packets that are urgent to be transmitted are transmitted first and the low-latency packets that are not urgent to be transmitted are transmitted later. Even under the condition that the channel is crowded, the transmission efficiency of the to-be-transmitted packets can be increased to make sure that the target apparatuses receive the low-latency packets within a time that is less than the requested target delay threshold value.

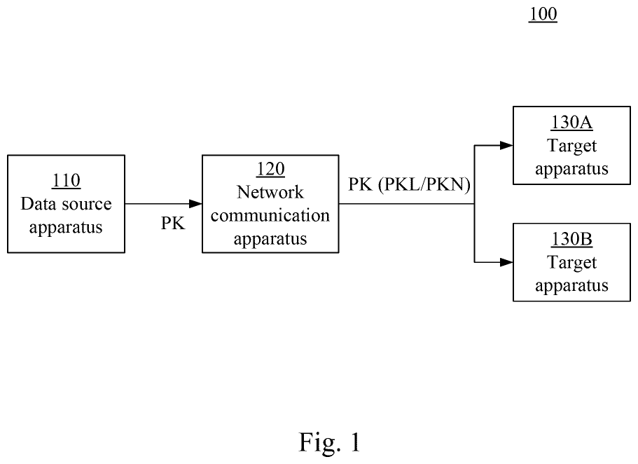

Reference is now made to FIG. 1. FIG. 1 illustrates a block diagram of a network communication system 100 according to an embodiment of the present invention. The network communication system 100 includes a data source apparatus 110, a network communication apparatus 120 and target apparatuses 130A~130B.

In an embodiment, the data source apparatus 110 is a data server or a cloud server. The network communication apparatus 120 is an access point apparatus. Each of the target apparatuses 130A~130B is a station apparatus. The data source apparatus 110 and the network communication apparatus 120 may communicate with each other through a wired network or a wireless network. The network communication apparatus 120 and the target apparatuses 130A~130B may communicate with each other through a wireless network established based on such as, but not limited to WiFi communication protocol.

In a usage scenario, the target apparatuses 130A~130B may operate different application programs to submit different service requirements. For example, the target apparatuses 130A~130B may operate a video call application or a real-time gaming application that has a low-latency requirement. In an embodiment, these application programs that have the low-latency requirement may submit the low-latency requirement that corresponds to a delay time of a data packet that is not higher than 10 milliseconds.

On the other hand, the target apparatuses 130A~130B may operate a video streaming application or a device remote controlling application that has a non-low-latency requirement. In an embodiment, these application programs that have the non-low-latency requirement may submit the non-low-latency requirement that allows a delay time of a data packet up to 100 to 1000 milliseconds.

According to the service requirements of the target apparatuses 130A~130B, the network communication apparatus 120 may receive a plurality of to-be-transmitted packets PK from the data source apparatus 110 and transmit the to-be-transmitted packets PK to the target apparatus 130A or the target apparatuses 130B according to target address information in the to-be-transmitted packets PK.

It is appreciated that in the network communication system 100 in FIG. 1, only one data source apparatus 110 is exemplarily illustrated. In practical applications, the network communication system 100 may include a plurality of data source apparatuses 110 providing different services such that the network communication apparatus 120 receives the to-be-transmitted packets PK having different data types from different data source apparatuses 110 and transmits the to-be-transmitted packets PK to the target apparatuses 130A~130B. The present invention is not limited thereto.

According to the different service requirements submitted by the target apparatuses 130A~130B, the network communication apparatus 120 can be equipped with a dynamic packet transmission sorting mechanism to increase the transmission efficiency of the to-be-transmitted packets PK to further satisfy the low-latency requirement of the target apparatuses 130A~130B. The configuration and operation of the network communication apparatus 120 are described in detail in the following paragraphs.

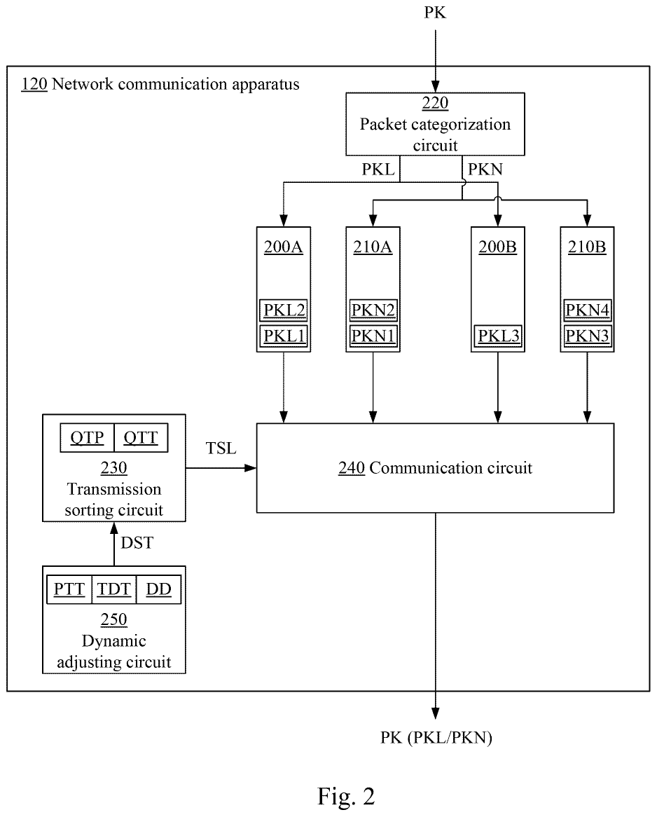

Reference is now made to FIG. 2. FIG. 2 illustrates a block diagram of the network communication apparatus 120 having the dynamic packet transmission sorting mechanism according to an embodiment of the present invention. The network communication apparatus 120 includes a plurality of low-latency queue circuits 200A~200B, a plurality of non-low-latency queue circuits 210A~210B, a packet categorization circuit 220, a transmission sorting circuit 230, a communication circuit 240 and a dynamic adjusting circuit 250.

The packet categorization circuit 220 is configured to categorize the to-be-transmitted packets PK. More specifically, the packet categorization circuit 220 may retrieve a plurality of low-latency packets PKL having the low-latency requirement and a plurality of non-low-latency packets PKN having the non-low-latency requirement from the to-be-transmitted packets PK such that the circuits in the network communication apparatus 120 perform different processings based on the different packet types. In an embodiment, the packet categorization circuit 220 may analyze the to-be-transmitted packets PK to determine whether the to-be-transmitted packets PK have the low-latency requirement according to entries related to the data type in each of the to-be-transmitted packets PK.

The processing that the circuits in the network communication apparatus 120 perform on the low-latency packets PKL is described first in the following paragraphs.

After retrieving the low-latency packets PKL having the low-latency requirement from the to-be-transmitted packets PK, the packet categorization circuit 220 sets each of the low-latency packets PKL to be a selected low-latency packet to determine a low-latency packet target apparatus that corresponds to the selected low-latency packet. In an embodiment, the packet categorization circuit 220 may analyze each of the low-latency packets PKL to determine the corresponding low-latency packet target apparatus according to the entries related to target address information included by each of the low-latency packets PKL.

The packet categorization circuit 220 further stores the selected low-latency packet in a selected low-latency queue circuit disposed correspondingly to the low-latency packet target apparatus in the low-latency queue circuits 200A~200B.

More specifically, the network communication apparatus 120 may set the low-latency queue circuits corresponding to different target apparatuses. Take the apparatuses in FIG. 1 and FIG. 2 as an example, the network communication apparatus 120 sets the low-latency queue circuit 200A to be corresponding to the target apparatus 130A and sets the low-latency queue circuit 200B to be corresponding to the target apparatus 130B.

For example, when the selected low-latency packet is determined to correspond to the target apparatus 130A, the packet categorization circuit 220 sets the low-latency queue circuit 200A to be the selected low-latency queue circuit and stores the selected low-latency packet in the low-latency queue circuit 200A. On the other hand, when the selected low-latency packet is determined to correspond to the target apparatus 130B, the packet categorization circuit 220 sets the low-latency queue circuit 200B to be the selected low-latency queue circuit and stores the selected low-latency packet in the low-latency queue circuit 200B. In FIG. 2, the low-latency queue circuit 200A is exemplarily illustrated to store two low-latency packets PKL1 and PKL2 and the low-latency queue circuit 200B is exemplarily illustrated to store one low-latency packet PKL3.

The transmission sorting circuit 230 is configured to calculate a queue time parameter QTP of the selected low-latency packet to be transmitted in each of a plurality of transmission timings so as to be sorted with the other low-latency packets according to the queue time parameter QTP to update a sorting list TSL. Moreover, the communication circuit 240 is configured to transmit the low-latency packets PKL in an order according to the sorting list TSL, so as to transmit the selected low-latency packet to the low-latency packet target apparatus.

In an embodiment, the low-latency packet having the ranking that is the most ahead (which is the low-latency packet that is stored earliest) in each of the low-latency queue circuits 200A~200B is the low-latency packet to be transmitted. As a result, for the low-latency queue circuit 200A, the low-latency packets PKL1 is the low-latency packets to be transmitted. For the low-latency queue circuit 200B, the low-latency packet PKL3 is the low-latency packet to be transmitted since only the low-latency packet PKL3 is stored therein.

In each of the transmission timings that allows the packets to be transmitted, the transmission sorting circuit 230 calculates the queue time parameter QTP for each of the low-latency packets to be transmitted (e.g., the low-latency packets PKL1 and PKL3 described above) and performs sorting on the low-latency packets to be transmitted to generate the sorting list TSL.

The communication circuit 240 transmits the low-latency packets in an order according to the sorting list TSL to the target apparatuses 130A~130B. In an embodiment, the communication circuit 240 may include a transmission circuit (TX, not illustrated in the figure) and a receiving circuit (RX, not illustrated in the figure) such that the low-latency packets are transmitted by using the transmission circuit to the corresponding target apparatuses 130A~130B.

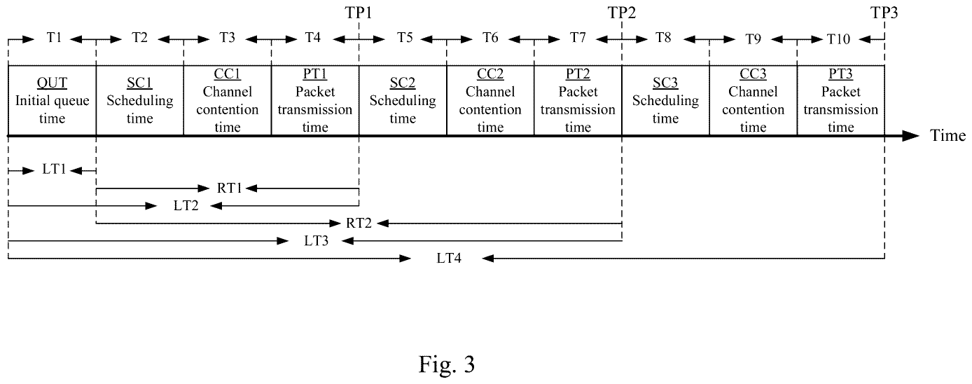

In an embodiment, the queue time parameter QTP described above is ratio between an exceeding time and a dynamic service time threshold value DST configured for the corresponding selected low-latency queue circuit, the exceeding time being an amount of time that a total queue time QTT that the selected low-latency packet is stored in the selected low-latency queue circuit exceeds the dynamic service time threshold value DST. The accumulation of the total queue time QTT is described first by referring to FIG. 3.

Reference is now made to FIG. 3. FIG. 3 illustrates a diagram of the transmission timings of the low-latency packets according to an embodiment of the present invention.

In an initial queue time QUT that the time period T1 corresponds to, selected low-latency packet begins to be stored in the selected low-latency queue circuit. In a scheduling time SC1 that the time period T2 corresponds to, the transmission sorting circuit 230 is configured to perform sorting to update the sorting list TSL. In a channel contention time CC1 that the time period T3 corresponds to, the communication circuit 240 starts to transmit the low-latency packet according to the sorting list TSL. In a packet transmission time PT1 that the time period T4 corresponds to, the low-latency packet is transmitted to the target apparatus through the wireless channel.

In the first usage scenario, the low-latency packet transmitted in the packet transmission time PT1 (i.e., the time period T4) by the communication circuit 240 is the selected low-latency packet, where such a selected low-latency packet does not need to be resent and is received by the low-latency packet target apparatus at the time point TP1 corresponding to the end of the packet transmission time PT1 (i.e., the time period T4).

Under such a condition, the total queue time QTT of such a selected low-latency packet is a sum of time LT1 of the initial queue time QUT, which is equivalent to the length of the time period T1.

In the second usage scenario, the low-latency packet transmitted in the packet transmission time PT1 (i.e., the time period T4) by the communication circuit 240 is one of the other low-latency packets having the ranking that is more ahead instead of the selected low-latency packet such that such a selected low-latency packet needs to be resent. Under such a condition, such a selected low-latency packet needs to stay in the corresponding selected low-latency queue circuit. The time from the time period T2 to the time period T4 becomes a retransmission queue time RT1.

After the packet transmission time PT1 (i.e., the time period T4) ends, a scheduling time SC2 that the time period T5 corresponds to, a channel contention times CC2 that the time period T6 corresponds to and a packet transmission time PT2 that the time period T7 corresponds to proceed in turn such that the low-latency packet is transmitted to the target apparatus through the wireless channel. When the low-latency packet transmitted in the packet transmission time PT2 (i.e., the time period T7) by the communication circuit 240 is the selected low-latency packet, such a selected low-latency packet is received by the low-latency packet target apparatus at the time point TP2 corresponding to the end of the packet transmission time PT2 (i.e., the time period T7).

Under such a condition, the total queue time QTT of such a selected low-latency packet is a sum of time LT2 of the initial queue time QUT and the retransmission queue time RT1, which is equivalent to the length from the time period T1 to the time period T4. The retransmission queue time RT1 includes the scheduling time SC1, the channel contention time CC1 and the packet transmission time PT1.

In the third usage scenario, the low-latency packet transmitted in the packet transmission time PT2 (i.e., the time period T7) by the communication circuit 240 is still one of the other low-latency packets having the ranking that is more ahead instead of the selected low-latency packet such that such a selected low-latency packet still needs to be resent. Under such a condition, such a selected low-latency packet still needs to stay in the corresponding selected low-latency queue circuit. The time from the time period T2 to the time period T7 becomes a retransmission queue time RT2.

After the packet transmission time PT2 (i.e., the time period T7) ends, a scheduling time SC3 that the time period T8 corresponds to, a channel contention time CC3 that the time period T9 corresponds to and a packet transmission time PT3 that the time period T10 corresponds to proceed in turn such that the low-latency packet is transmitted to the target apparatus through the wireless channel. When the low-latency packet transmitted in the packet transmission time PT3 (i.e., the time period T10) by the communication circuit 240 is the selected low-latency packet, such a selected low-latency packet is received by the low-latency packet target apparatus at the time point TP3 corresponding to the end of the packet transmission time PT3 (i.e., the time period T10).

Under such a condition, the total queue time QTT of such a selected low-latency packet is a sum of LT3 of the initial queue time QUT and the retransmission queue time RT2, which is equivalent to the length from the time period T1 to the time period T7. The retransmission queue time RT2 includes two scheduling times SC1 and SC2, two channel contention times CC1 and CC2 and two packet transmission times PT1 and PT2.

In the times described above, the initial queue time QUT can be obtained according to the storage operation performed on the low-latency packets by the low-latency queue circuits 200A and 200B. The scheduling times SC1 to SC3 can be obtained according to the scheduling operation performed by the transmission sorting circuit 230. The channel contention times CC1 to CC3 can be obtained according to the transmission behavior performed by the communication circuit 240.

Further, the packet transmission times PT1 to PT3 can be calculated according to the acknowledgement (ACK, not illustrated in the figure) returned by the low-latency packet target apparatus corresponding to the selected low-latency packet. More specifically, when the selected low-latency packet is received, the low-latency packet target apparatus documents the receiving time point and returns the acknowledgement of receipt information including the receiving time point. Each of the packet transmission times PT1 to PT3 can be calculated according to the difference between the receiving time point and the transmission time point that the communication circuit 240 transmits the selected low-latency packet.

It is appreciated that the embodiments described above use the conditions that the selected low-latency packet does not need to be resent, is transmitted after one retransmission attempt and is transmitted after two retransmission attempts as an example. Actually, the selected low-latency packet can be transmitted to the low-latency packet target apparatus after N retransmission attempts. The total queue time of the selected low-latency packet is a sum of time of the initial queue time and the retransmission queue time, where the retransmission queue time includes N scheduling times and N channel contention times. N is an integer that is larger than or equals to 0.

As a result, after the times are obtained, the transmission sorting circuit 230 calculates the total queue time QTT accordingly. The queue time parameter QTP is calculated by dividing the dynamic service time threshold value DST by a subtraction result between the total queue time QTT and the dynamic service time threshold value DST and is expressed by the following equation:

QTP=(QTT−DST)/DST (equation 1)

For the embodiment illustrated in FIG. 2, when the total queue time QTT of the low-latency packet PKL1 to be transmitted is 11 milliseconds and the dynamic service time threshold value DST is configured to be 10 milliseconds, the queue time parameter QTP of the low-latency packet PKL1 is (11−10)/10=1/10=0.1. When the total queue time QTT of the low-latency packet PKL3 to be transmitted is 6 milliseconds and the dynamic service time threshold value DST is configured to be 5 milliseconds, the queue time parameter QTP of the low-latency packet PKL3 is (6−5)/5=1/5=0.2.

Though the total queue time QTT of each of the low-latency packet PKL1 and the low-latency packet PKL3 exceeds the respective dynamic service time threshold value DST for 1 millisecond in the embodiments described above, the ratio between the exceeding time that the total queue time QTT exceeds the dynamic service time threshold value DST and the dynamic service time threshold value DST can be obtained based on the calculation of the queue time parameter QTP. As a result, the queue time parameter QTP can be an indication of the urgency degree of the transmission of the low-latency packet PKL1 and the low-latency packet PKL3.

Under such a condition, when the queue time parameter QTP that the selected low-latency packet corresponds to has a larger value, the selected low-latency packet has a higher degree of urgency of transmission. As a result, the ranking of the selected low-latency packet in the sorting list TSL is further ahead. On the contrary, when the queue time parameter QTP that the selected low-latency packet corresponds to has a smaller value, the selected low-latency packet has a lower degree of urgency of transmission. As a result, the ranking of the selected low-latency packet in the sorting list TSL is further behind.

Since the queue time parameter QTP of the low-latency packet PKL3 is larger than the queue time parameter QTP of the low-latency packet PKL1, the ranking of the low-latency packet PKL3 in the sorting list TSL is more ahead and the ranking of the low-latency packet PKL1 in the sorting list TSL is more behind. The communication circuit 240 transmits the low-latency packet PKL3 first according to the sorting list TSL.

The dynamic adjusting circuit 250 is configured to accumulate a total packet transmission time PTT from a first time point that the selected low-latency packet begins to be stored in the selected low-latency queue circuit to a second time point that the selected low-latency packet is received by the low-latency packet target apparatus, and to calculate a difference DD between the total packet transmission time PTT and a target delay threshold value TDT that the low-latency packet target apparatus requests to dynamically adjust the dynamic service time threshold value DST according to the difference.

In an embodiment, the total packet transmission time PTT is a sum of time of the total queue time QTT, a final scheduling time, a final channel contention time and a packet transmission time. The total packet transmission time PTT is described by referring to FIG. 3 and the corresponding usage scenarios again.

In the first usage scenario, when the selected low-latency packet does not need to be retransmitted, the total queue time QTT is the sum of time LT1, the final scheduling time is the scheduling time SC1, the final channel contention time is the channel contention time CC1, and the packet transmission time is the packet transmission time PT1. As a result, the total packet transmission time PTT of selected low-latency packet in the first usage scenario is the sum of time LT2 of the times described above.

In the second usage scenario, when the selected low-latency packet is transmitted after one retransmission attempt, the total queue time QTT is the sum of time LT2, the final scheduling time is the scheduling time SC2, the final channel contention time is the channel contention time CC2 and the packet transmission time is the packet transmission time PT2. As a result, the total packet transmission time PTT of selected low-latency packet in the second usage scenario is the sum of time LT3 of the times described above.

In the third usage scenario, when the selected low-latency packet is transmitted after two retransmission attempts, the total queue time QTT is the sum of time LT3, the final scheduling time is the scheduling time SC3, the final channel contention time is the channel contention time CC3 and the packet transmission time is the packet transmission time PT3. As a result, the total packet transmission time PTT of selected low-latency packet in the third usage scenario is the sum of time LT4 of the times described above.

After obtaining the times described above, the dynamic adjusting circuit 250 calculates the total packet transmission time PTT. The method that the dynamic adjusting circuit 250 uses to obtain these times is the same as the method used by the transmission sorting circuit 230. The detail is not described herein.

The target delay threshold value TDT is an upper limit value of the delay amount that the low-latency packet target apparatus requests. When the total packet transmission time PTT of the low-latency packet exceeds the target delay threshold value TDT, the possibility that the low-latency packet target apparatus does not receive the low-latency packet accurately is higher. In an embodiment, the target delay threshold value TDT is configured by the low-latency packet target apparatus and transmitted to the network communication apparatus 120 to be stored by the dynamic adjusting circuit 250. In another embodiment, the target delay threshold value TDT is configured by the dynamic adjusting circuit 250.

The difference DD is calculated by subtracting the target delay threshold value TDT from the total packet transmission time PTT by the dynamic adjusting circuit 250 and is expressed by the following equation:

DD=PTT−TDT (equation 2)

The dynamic adjusting circuit 250 may dynamically adjust the dynamic service time threshold value DST according to the difference DD based on different methods.

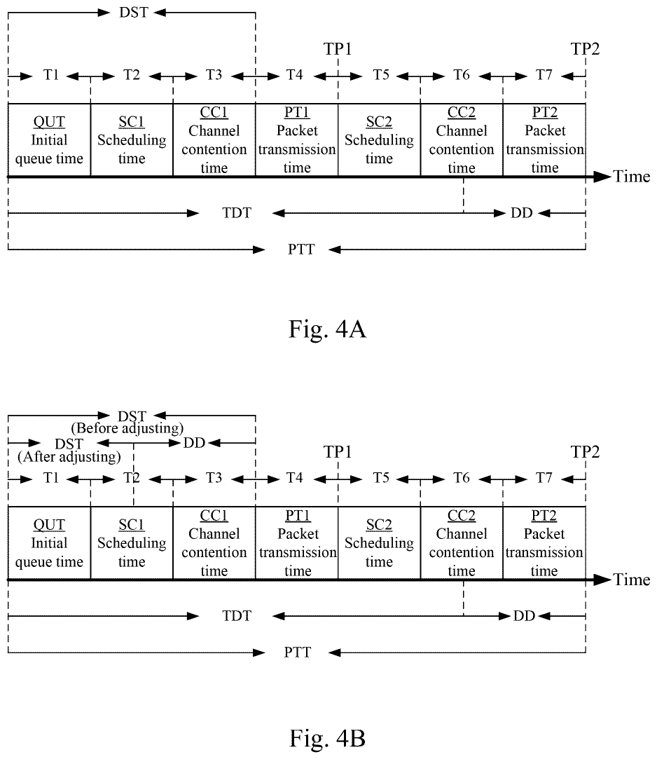

Reference is now made to FIGS. 4A and 4B at the same time. FIG. 4A and FIG. 4B illustrate diagrams of the transmission timings of the low-latency packets according to an embodiment of the present invention.

FIG. 4A and FIG. 4B actually illustrate the process that the low-latency packet is transmitted after one retransmission attempt from the time period T1 to the time period T7 in FIG. 3. The operation of the circuits in the network communication apparatus 120 in these times is identical to the operation described in FIG. 3. The detail is not described herein.

FIG. 4A further illustrates the total packet transmission time PTT, the target delay threshold value TDT and the difference DD therebetween. In such an embodiment, the difference DD indicates that the total packet transmission time PTT exceeds the target delay threshold value TDT. The dynamic adjusting circuit 250 determines that the low-latency packet target apparatus may not receive the low-latency packet accurately and decreases the dynamic service time threshold value DST according to an amount of an absolute value of the difference DD. As illustrated in FIG. 4B, the dynamic service time threshold value DST labeled as “before adjusting” is decreased by the amount of the absolute value of the difference DD and becomes the dynamic service time threshold value DST labeled as “after adjusting”.

As a result, for the subsequent low-latency packets that correspond to such a low-latency packet target apparatus, the transmission sorting circuit 230 is easier to obtain a larger value of the queue time parameter QTP by performing calculation on these low-latency packets. The subsequent low-latency packets are easier to have a ranking that is more ahead in the sorting list TSL such that the communication circuit 240 may transmit the subsequent low-latency packets first.

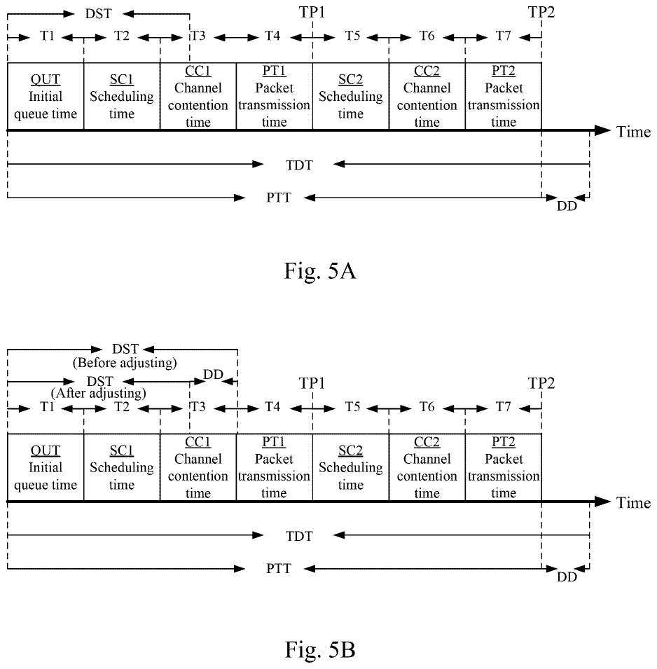

Reference is now made to FIGS. 5A and 5B. FIG. 5A and FIG. 5B illustrate diagrams of the transmission timings of the low-latency packets according to an embodiment of the present invention.

FIG. 5A and FIG. 5B actually illustrate the process that the low-latency packet is transmitted after one retransmission attempt from the time period T1 to the time period T7 in FIG. 3. The operation of the circuits in the network communication apparatus 120 in these times is identical to the operation described in FIG. 3. The detail is not described herein.

FIG. 5A further illustrates the total packet transmission time PTT, the target delay threshold value TDT and the difference DD therebetween. In such an embodiment, the difference DD indicates that the total packet transmission time PTT does not exceed the target delay threshold value TDT. The dynamic adjusting circuit 250 determines that the low-latency packet target apparatus has sufficient time to receive the low-latency packet and increases the dynamic service time threshold value DST according to an amount of an absolute value of the difference DD. As illustrated in FIG. 5B, the dynamic service time threshold value DST labeled as “before adjusting” is increased by the amount of the absolute value of the difference DD and becomes the dynamic service time threshold value DST labeled as “after adjusting”.

As a result, for the subsequent low-latency packets that correspond to such a low-latency packet target apparatus, the transmission sorting circuit 230 is easier to obtain a smaller value of the queue time parameter QTP by performing calculation on these low-latency packets. The subsequent low-latency packets are easier to have a ranking that is more behind in the sorting list TSL such that the communication circuit 240 may transmit the subsequent low-latency packets later.

In an embodiment, the dynamic service time threshold value DST can configured to have a predetermined value when the network communication apparatus 120 begins to operate and is adjusted according to the transmission result in each of the transmission timings. The calculation related to the sorting corresponding to the subsequent transmission timing is performed according to the adjusted dynamic service time threshold value DST. In an embodiment, the predetermined value described above can be such as, but not limited to the target delay threshold value TDT. However, the present invention is not limited thereto.

The process of the circuits in the network communication apparatus 120 performed on the non-low-latency packets PKN is described in the following paragraphs.

The packet categorization circuit 220 retrieves the non-low-latency packets PKN having the non-low-latency requirement from the to-be-transmitted packets PK and sets each of the non-low-latency packets PKN to be a selected non-low-latency packet to determine a non-low-latency packet target apparatus that corresponds to the selected non-low-latency packet from the target apparatuses. In an embodiment, the packet categorization circuit 220 may analyze the non-low-latency packets PKN to determine the corresponding non-low-latency packet target apparatus according to the entries related to target address information included by each of the non-low-latency packets PKN.

The packet categorization circuit 220 further stores the selected non-low-latency packet in a selected non-low-latency queue circuit disposed correspondingly to the non-low-latency packet target apparatus in the non-low-latency queue circuits.

More specifically, the network communication apparatus 120 may set the non-low-latency queue circuits corresponding to different target apparatuses. Take the apparatuses in FIG. 1 and FIG. 2 as an example, the network communication apparatus 120 sets the non-low-latency queue circuit 210A to be corresponding to the target apparatus 130A and sets the non-low-latency queue circuit 210B to be corresponding to the target apparatus 130B.

For example, when the selected non-low-latency packet is determined t correspond to the target apparatus 130A, the packet categorization circuit 220 sets the non-low-latency queue circuit 210A to be the selected non-low-latency queue circuit and stores the selected non-low-latency packet in the non-low-latency queue circuit 210A. On the other hand, when the selected non-low-latency packet is determined to correspond to the target apparatus 130B, the packet categorization circuit 220 sets the non-low-latency queue circuit 210B to be the selected non-low-latency queue circuit and stores the selected non-low-latency packet in the non-low-latency queue circuit 210B. In FIG. 2, the non-low-latency queue circuit 210A is exemplarily illustrated to store two non-low-latency packets PKN1 and PKN2 and the non-low-latency queue circuit 210B is exemplarily illustrated to store two non-low-latency packets PKN3 and PKN4.

The communication circuit 240 is configured to, in each of the transmission timings, transmit the selected non-low-latency packet to the non-low-latency packet target apparatus according to a transmission order of the selected non-low-latency queue circuit in the non-low-latency queue circuits 210A and 210B when the sorting list TSL does not include any one of low-latency packets PKL that is not transmitted yet or when the queue time parameter QTP of each of the low-latency packets PKL is smaller than a predetermined value.

The condition that the sorting list TSL does not include any one of low-latency packets PKL that is not transmitted yet means that all the low-latency packets PKL are finished being transmitted. The condition that the queue time parameter QTP of each of the low-latency packets PKL is smaller than a predetermined value means that the low-latency packet target apparatuses have a sufficient time to receive the low-latency packets PKL. As a result, when one of the conditions described above is determined to occur, the communication circuit 240 transmits the non-low-latency packets.

In an embodiment, a predetermined transmission order may be configured for the non-low-latency queue circuits 210A and 210B, e.g., the non-low-latency queue circuit 210A has a higher transmission order and the non-low-latency queue circuit 210B has a lower transmission order. As a result, the communication circuit 240 may transmit the non-low-latency packets in the non-low-latency queue circuits 210A and 210B in an interlaced manner. Take the condition in FIG. 2 as an example, the communication circuit 240 may transmit the non-low-latency packets PKN1, PKN3, PKN2 and PKN4 in turn to the corresponding target apparatuses.

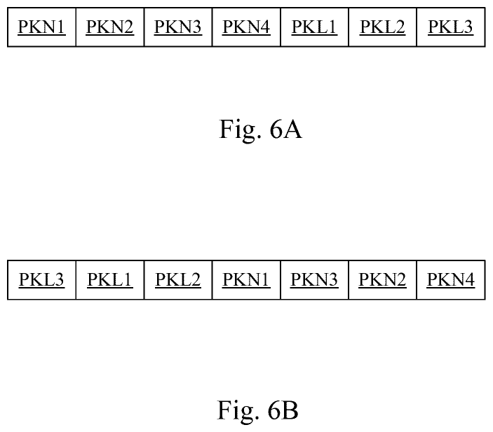

Reference is now made to FIG. 6A. FIG. 6A illustrates a diagram of the transmission order of the low-latency packets and the non-low-latency packets in some approaches.

In an embodiment, the receiving order of the to-be-transmitted packets PK is the non-low-latency packets PKN1~PKN4 and the low-latency packets PKL1~PKL3. As described in the previous embodiments, the non-low-latency packets PKN1, the non-low-latency packets PKN2, the low-latency packets PKL1 and the low-latency packets PKL2 correspond to the target apparatus 130A. The non-low-latency packets PKN3, the non-low-latency packets PKN4 and the low-latency packets PKL3 correspond to the target apparatus 130B.

The network communication apparatus in some approaches does not have the dynamic packet transmission sorting mechanism and include one queue circuit corresponding to the target apparatus 130A and another queue circuit corresponding to the target apparatus 130B such that the to-be-transmitted packets PK are transmitted in an order that is the same as the receiving order.

As illustrated in FIG. 6A, the transmission order of the to-be-transmitted packets PK is the non-low-latency packets PKN1~PKN4 and the low-latency packets PKL1~PKL3. Under such a condition, the low-latency packets PKL1~PKL3 that is more urgent to be transmitted cannot be transmitted first and have to be transmitted after the non-low-latency packets PKN1~PKN4 are finished being transmitted.

Reference is now made to FIG. 6B. FIG. 6B illustrates a diagram of the transmission order of the low-latency packets and the non-low-latency packets according to an embodiment of the present invention.

The network communication apparatus 120 of the present invention equipped with the dynamic packet transmission sorting mechanism categorizes the to-be-transmitted packets PK first and stores the low-latency packets and the non-low-latency packets in different queue circuits. Subsequently, the network communication apparatus 120 transmits the low-latency packet PKL1, the low-latency packet PKL2 and the low-latency packet PKL3 in the low-latency queue circuits first.

As illustrated in FIG. 6B, the low-latency packet PKL1, the low-latency packet PKL2 and the low-latency packet PKL3 are sorted according to the queue time parameters QTP thereof and are transmitted in an order of the low-latency packets PKL3, the low-latency packets PKL1 and the low-latency packets PKL2. Moreover, the network communication apparatus 120 of the present invention transmits the non-low-latency packets PKN1, PKN3, PKN2 and PKN4 in the non-low-latency queue circuits in turn.

As a result, the network communication apparatus having the dynamic packet transmission sorting mechanism of the present invention categorizes the to-be-transmitted packets first and further sorts the low-latency packets according to the queue time parameters thereof. The transmission of the low-latency packets can be performed and the dynamic service time threshold value related to the packets can be dynamically adjusted accordingly such that the low-latency packets that are urgent to be transmitted are transmitted first and the low-latency packets that are not urgent to be transmitted are transmitted later. Even under the condition that the channel is crowded, the transmission efficiency of the to-be-transmitted packets can be increased to make sure that the target apparatuses receive the low-latency packets within a time that is less than the requested target delay threshold value.

It is appreciated that at least one of the low-latency queue circuits 200A~200B, the non-low-latency queue circuits 210A~210B, the packet categorization circuit 220, the transmission sorting circuit 230, the communication circuit 240 and the dynamic adjusting circuit 250 included by the network communication apparatus 120 is implemented by software or firmware operated by a hardware circuit.

In a practical implementation, the packet categorization circuit 220 is implemented by software to analyze the to-be-transmitted packets PK. The low-latency queue circuits 200A~200B and the non-low-latency queue circuits 210A~210B can be disposed in a media access control (MAC) circuit implemented by a hardware circuit. The transmission sorting circuit 230 can be implemented by firmware or software to calculate the queue time parameter and update the sorting list. The dynamic adjusting circuit 250 may include one part implemented by a hardware circuit to accumulate the total packet transmission time, and another part implemented by firmware or software to calculate the difference DD and dynamically adjust the dynamic service time threshold value DST. The communication circuit 240 can be implemented by a hardware circuit. However, the present invention is not limited thereto.

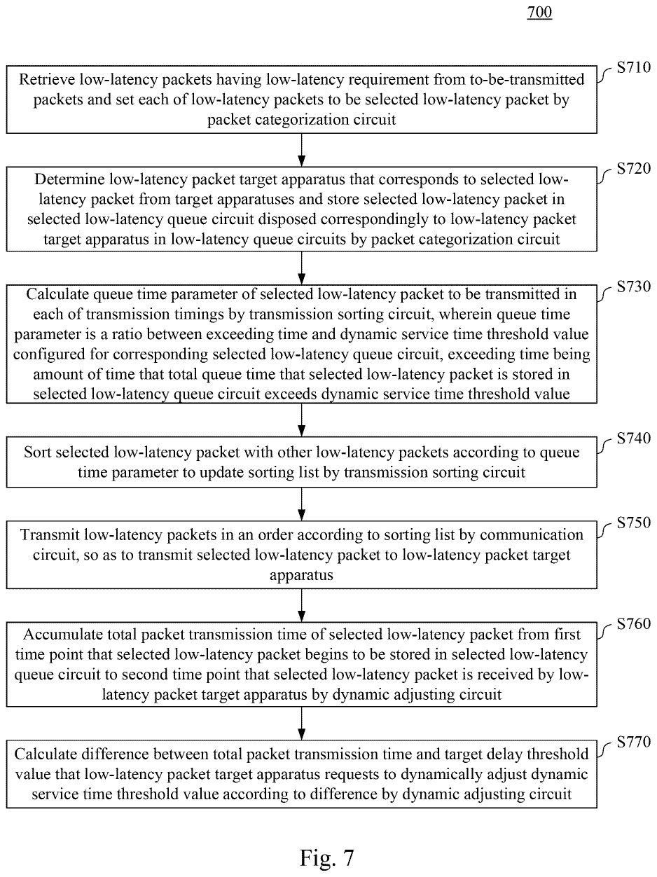

Reference is now made to FIG. 7. FIG. 7 illustrates a flow chart of a network communication method 700 according to an embodiment of the present invention.

In addition to the apparatus described above, the present disclosure further provides the network communication method 700 having the dynamic packet transmission sorting mechanism that can be used in such as, but not limited to, the network communication apparatus 100 in FIG. 1. As illustrated in FIG. 7, an embodiment of the network communication method 700 includes the following steps.

In step S710, the low-latency packets PKL having the low-latency requirement are retrieved from the to-be-transmitted packets PK and each of the low-latency packets PKL is set to be the selected low-latency packet by the packet categorization circuit 220.

In step S720, the low-latency packet target apparatus that corresponds to the selected low-latency packet is determined from the target apparatuses 130A~130B and the selected low-latency packet is further stored in a selected low-latency queue circuit disposed correspondingly to the low-latency packet target apparatus in the low-latency queue circuits 200A~200B by the packet categorization circuit 220.

In step S730, the queue time parameter QTP of the selected low-latency packet to be transmitted in each of the transmission timings is calculated by the transmission sorting circuit 230, wherein the queue time parameter is a ratio between the exceeding time and the dynamic service time threshold value DST configured for the corresponding selected low-latency queue circuit, the exceeding time being an amount of time that a total queue time QTT that the selected low-latency packet is stored in the selected low-latency queue circuit exceeds the dynamic service time threshold value DST.

In step S740, the selected low-latency packet is sorted with the other low-latency packets according to the queue time parameter QTP to update the sorting list TSL by the transmission sorting circuit 230.

In step S750, the low-latency packets are transmitted in an order according to the sorting list TSL by the communication circuit 240, so as to transmit the selected low-latency packet to the low-latency packet target apparatus.

In step S760, the total packet transmission time PTT of the selected low-latency packet from the first time point that the selected low-latency packet begins to be stored in the selected low-latency queue circuit to the second time point that the selected low-latency packet is received by the low-latency packet target apparatus is accumulated by the dynamic adjusting circuit 250.

In step S770, the difference DD between the total packet transmission time PTT and the target delay threshold value TDT that the low-latency packet target apparatus requests is calculated to dynamically adjust the dynamic service time threshold value DST according to the difference DD by the dynamic adjusting circuit 250.

It is appreciated that the embodiments described above are merely an example. In other embodiments, it should be appreciated that many modifications and changes may be made by those of ordinary skill in the art without departing, from the spirit of the disclosure.

In summary, the present invention discloses the network communication apparatus and the network communication method having a dynamic packet transmission sorting mechanism categorize to-be-transmitted packets first and further sort the low-latency packets according to the queue time parameters thereof. The transmission of the low-latency packets can be performed and the dynamic service time threshold value related to the packets can be dynamically adjusted accordingly such that the low-latency packets that are urgent to be transmitted are transmitted first and the low-latency packets that are not urgent to be transmitted are transmitted later. Even under the condition that the channel is crowded, the transmission efficiency of the to-be-transmitted packets can be increased to make sure that the target apparatuses receive the low-latency packets within a time that is less than the requested target delay threshold value.

The aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

What is claimed is:

1. A network communication apparatus having a dynamic packet transmission sorting mechanism, comprising:
a plurality of low-latency queue circuits;
a packet categorization circuit configured to retrieve a plurality of low-latency packets having a low-latency requirement from a plurality of to-be-transmitted packets and set each of the low-latency packets to be a selected low-latency packet to determine a low-latency packet target apparatus that corresponds to the selected low-latency packet from a plurality of target apparatuses and further store the selected low-latency packet in a selected low-latency queue circuit disposed correspondingly to the low-latency packet target apparatus in the low-latency queue circuits;
a transmission sorting circuit configured to calculate a queue time parameter of the selected low-latency packet to be transmitted in each of a plurality of transmission timings so as to be sorted with the other low-latency packets according to the queue time parameter to update a sorting list, wherein the queue time parameter is a ratio between an exceeding time and a dynamic service time threshold value configured for the corresponding selected low-latency queue circuit, the exceeding time being an amount of time that a total queue time that the selected low-latency packet is stored in the selected low-latency queue circuit exceeds the dynamic service time threshold value;
a communication circuit configured to transmit the low-latency packets in an order according to the sorting list, so as to transmit the selected low-latency packet to the low-latency packet target apparatus; and
a dynamic adjusting circuit configured to accumulate a total packet transmission time of the selected low-latency packet from a first time point that the selected low-latency packet begins to be stored in the selected low-latency queue circuit to a second time point that the selected low-latency packet is received by the low-latency packet target apparatus, and to calculate a difference between the total packet transmission time and a target delay threshold value that the low-latency packet target apparatus requests to dynamically adjust the dynamic service time threshold value according to the difference.

2. The network communication apparatus of claim 1, wherein when the queue time parameter that the selected low-latency packet corresponds to has a larger value, a ranking of the selected low-latency packet in the sorting list is further ahead.

3. The network communication apparatus of claim 1, wherein the dynamic adjusting circuit decreases the dynamic service time threshold value according to an amount of an absolute value of the difference when the difference indicates that the total packet transmission time exceeds the target delay threshold value and increases the dynamic service time threshold value according to the amount of the absolute value of the difference when the difference indicates that the total packet transmission time does not exceed the target delay threshold value.

4. The network communication apparatus of claim 1, wherein the queue time parameter is calculated by dividing the dynamic service time threshold value by a subtraction result between the total queue time and the dynamic service time threshold value.

5. The network communication apparatus of claim 1, wherein the target delay threshold value is configured by the low-latency packet target apparatus and transmitted to the network communication apparatus to be stored by the dynamic adjusting circuit, or is configured by the dynamic adjusting circuit.

6. The network communication apparatus of claim 1, wherein the total packet transmission time is a first sum of time of the total queue time, a final scheduling time, a final channel contention time and a packet transmission time, and the packet transmission time is calculated according to an acknowledgement returned from the low-latency packet target apparatus corresponding to the selected low-latency packet;
wherein when the selected low-latency packet is transmitted to the low-latency packet target apparatus after N retransmission attempts, the total queue time is a second sum of time of an initial queue time and a retransmission queue time that the selected low-latency packet stores in the selected low-latency queue circuit and the retransmission queue time comprises N scheduling times, N channel contention times and N packet transmission times, N being an integer that is larger than or equals to 0.

7. The network communication apparatus of claim 1, further comprising a plurality of non-low-latency queue circuits, the packet categorization circuit is further configured to retrieve a plurality of non-low-latency packets having a non-low-latency requirement from the to-be-transmitted packets and set each of the non-low-latency packets to be a selected non-low-latency packet to determine a non-low-latency packet target apparatus that corresponds to the selected non-low-latency packet from the target apparatuses and further store the selected non-low-latency packet in a selected non-low-latency queue circuit disposed correspondingly to the non-low-latency packet target apparatus in the non-low-latency queue circuits.

8. The network communication apparatus of claim 7, wherein the communication circuit is configured to, in each of the transmission timings, transmit the selected non-low-latency packet to the non-low-latency packet target apparatus according to a transmission order of the selected non-low-latency queue circuit in the non-low-latency queue circuits when the sorting list does not comprise any one of low-latency packets that is not transmitted yet or when the queue time parameter of each of the low-latency packets is smaller than a predetermined value.

9. The network communication apparatus of claim 1, wherein at least one of the low-latency queue circuits, the packet categorization circuit, the transmission sorting circuit, the communication circuit and the dynamic adjusting circuit is implemented by software or firmware operated by a hardware circuit.

10. The network communication apparatus of claim 1, wherein the network communication apparatus is an access point apparatus and each of the target apparatuses is a station apparatus.

11. A network communication method having a dynamic packet transmission sorting mechanism, comprising:
retrieving a plurality of low-latency packets having a low-latency requirement from a plurality of to-be-transmitted packets and setting each of the low-latency packets to be a selected low-latency packet by a packet categorization circuit;
determining a low-latency packet target apparatus that corresponds to the selected low-latency packet from a plurality of target apparatuses and further storing the selected low-latency packet in a selected low-latency queue circuit disposed correspondingly to the low-latency packet target apparatus in a plurality of low-latency queue circuits by the packet categorization circuit;
calculating a queue time parameter of the selected low-latency packet to be transmitted in each of a plurality of transmission timings by a transmission sorting circuit, wherein the queue time parameter is a ratio between an exceeding time and a dynamic service time threshold value configured for the corresponding selected low-latency queue circuit, the exceeding time being an amount of time that a total queue time that the selected low-latency packet is stored in the selected low-latency queue circuit exceeds the dynamic service time threshold value;
sorting the selected low-latency packet with the other low-latency packets according to the queue time parameter to update a sorting list by the transmission sorting circuit;
transmitting the low-latency packets in an order according to the sorting list by a communication circuit, so as to transmit the selected low-latency packet to the low-latency packet target apparatus;
accumulating a total packet transmission time of the selected low-latency packet from a first time point that the selected low-latency packet begins to be stored in the selected low-latency queue circuit to a second time point that the selected low-latency packet is received by the low-latency packet target apparatus by a dynamic adjusting circuit; and
calculating a difference between the total packet transmission time and a target delay threshold value that the low-latency packet target apparatus requests to dynamically adjust the dynamic service time threshold value according to the difference by the dynamic adjusting circuit.

12. The network communication method of claim 11, wherein when the queue time parameter that the selected low-latency packet corresponds to has a larger value, a ranking of the selected low-latency packet in the sorting list is further ahead.

13. The network communication method of claim 11, further comprising:
decreasing the dynamic service time threshold value according to an amount of an absolute value of the difference when the difference indicates that the total packet transmission time exceeds the target delay threshold value and increasing the dynamic service time threshold value according to the amount of the absolute value of the difference when the difference indicates that the total packet transmission time does not exceeds the target delay threshold value by the dynamic adjusting circuit.

14. The network communication method of claim 11, wherein the queue time parameter is calculated by dividing the dynamic service time threshold value by a subtraction result between the total queue time and the dynamic service time threshold value.

15. The network communication method of claim 11, further comprising:
configuring the target delay threshold value by the low-latency packet target apparatus and transmitting the target delay threshold value to the network communication apparatus to be stored by the dynamic adjusting circuit, or configuring the target delay threshold value by the dynamic adjusting circuit.

16. The network communication method of claim 11, wherein the total packet transmission time is a first sum of time of the total queue time, a final scheduling time, a final channel contention time and a packet transmission time, and the packet transmission time is calculated according to an acknowledgement returned from the low-latency packet target apparatus corresponding to the selected low-latency packet;
wherein when the selected low-latency packet is transmitted to the low-latency packet target apparatus after N retransmission attempts, the total queue time is a second sum of time of an initial queue time and a retransmission queue time that the selected low-latency packet stores in the selected low-latency queue circuit and the retransmission queue time comprises N scheduling times, N channel contention times and N packet transmission times, N being an integer that is larger than or equals to 0.

17. The network communication method of claim 11, further comprising:
retrieving a plurality of non-low-latency packets having a non-low-latency requirement from the to-be-transmitted packets and setting each of the non-low-latency packets to be a selected non-low-latency packet by the packet categorization circuit; and
determining a non-low-latency packet target apparatus that corresponds to the selected non-low-latency packet from the target apparatuses and further storing the selected non-low-latency packet in a selected non-low-latency queue circuit disposed correspondingly to the non-low-latency packet target apparatus in a plurality non-low-latency queue circuits by the packet categorization circuit.

18. The network communication method of claim 17, further comprising:
in each of the transmission timings, transmitting the selected non-low-latency packet to the non-low-latency packet target apparatus according to a transmission order of the selected non-low-latency queue circuit in the non-low-latency queue circuits by the communication circuit when the sorting list does not comprise any one of low-latency packets that is not transmitted yet or when the queue time parameter of each of the low-latency packets is smaller than a predetermined value.

19. The network communication method of claim 11, wherein at least one of the low-latency queue circuits, the packet categorization circuit, the transmission sorting circuit, the communication circuit and the dynamic adjusting circuit is implemented by software or firmware operated by a hardware circuit.

20. The network communication method of claim 11, wherein the network communication apparatus is an access point apparatus and each of the target apparatuses is a station apparatus.
